(19) United States
(12) Patent Application Publication
(10) Pub. No.: US 2025/0144986 A1
(43) Pub. Date: May 8, 2025

(54) Anti-detachment hook structure for a car cover

(71) Applicant: ZHEJIANG SURPASS AUTO PARTS CO.,LTD., Wenzhou City (CN)

(72) Inventor: Shiqi Zheng, Wenzhou City (CN)

(21) Appl. No.: 18/898,622

(22) Filed: Sep. 26, 2024

(30) Foreign Application Priority Data
Nov. 6, 2023 (CN) 202311468412.3

(51) Int. Cl. B60J 7/19

(52) U.S. Cl. CPC B60J 7/198

(57) ABSTRACT

The present invention discloses an anti-detachment hook structure for a car cover, including a secure clamp and a hook, one end of the secure clamp is connected to a car body or a side rail, the other end of the secure clamp is connected to the car cover by a hook. The present invention prevents the car cover from falling off when the vehicle is traveling by providing the secure clamp and using the secure clamp to connect the car cover to the side rail or the vehicle body.

### CROSS REFERENCE TO RELATED APPLICATION

This application claims priority benefit of Chinese patent Application No. 202311468412.3, filed on Nov. 6, 2023, and the entire contents of which are incorporated herein by reference.

### TECHNICAL FIELD

This invention is relevant to automotive spare parts, especially an anti-detachment hook structure for a car cover.

### BACKGROUND TECHNOLOGY

Pick-up truck, also known as a sedan truck, have the comfort of a sedan without losing power. Pickup trucks have a strong cargo capacity and the ability to adapt to poor road surface, its comprehensive performance makes it one of the most common models of off-road vehicles nowadays.

Existing pickup trucks are basically open-top structures, the cargo hopper does not have a cover, and if you want a cover you have to install it separately. Due to the different widths of different models of cargo hopper, and most of the existing cover is universal cover, which makes the cover easy to slide after installation. At present, the connection of the cover is to connect the side rails with the hopper through the clamp, and then connect the cover with the side rails through the wrench, this connection will not cause problem in the normal road driving, but in the bumpy road, or after long-term use, there will be cover loosening, sliding or other problems, and in serious cases, may lead to the cover falling off, which is a great safety hazard.

### About the Invention

To overcome the deficiencies of the prior art, the present invention provides an anti-detachable hook structure of a car cover, which adds an anti-detachable hook structure to the original design to ensure that the car cover will not fall off.

In order to solve the above problems of the existing technology, the technical solution adopted in the invention is as follows:

An anti-detachment hook structure for a car cover, including a secure clamp and a lifting hook.

One end of the secure clamp is connected to the car body or the side rail, the other end of the secure clamp is connected to the car cover by the lifting hook.

By providing the secure clamp, the secure clamp is utilized to connect the car cover to the side rail or the car body to prevent the car cover from falling off when the car is traveling.

The car cover includes a large front bar, a folding section and a tail bar, wherein the large front bar cannot be opened, the car cover opens only the tail bar and the folding section, whereas the secure camp of the present invention is connected to the large front bar.

Further, the secure clamp includes a secure belt, a secure buckle and a clamp assembly, the clamp assembly is connected to the car body or the side rail, the clamp assembly is connected to the secure buckle, the secure buckle is connected to the lifting hook by the secure belt, both the secure buckle and the lifting hook are made of metal or high-strength plastic. The clamp assembly is used to connect the side rail to the car body, the secure clamp is in the form of a secure buckle and a secure belt, the secure buckle and the secure belt are utilized to connect the lifting hook and the clamp assembly, the secure belts have certain elasticity so that the clamps do not cause damage to the cover or body of the car as it passes over bumpy roads, and the secure belts are able to pull the car cover tight.

Further, the clamp assembly includes a left clamp and a right clamp, the left clamp and the right clamp are connected by screws, the left clamp is provided with a left clamp fixing port, the secure buckle is connected to the left clamp fixing port, the clamp assembly is used to clamp the car cover to the side rail, so that the car cover can fit various car models, as the left clamp is located on the inner side, the left clamp fixing port is provided on the left clamp for connecting the secure buckle, the left clamp fixing port can be set separately, it also can be set in connection with the tension port, which facilitates the processing of the left clamp.

Further, the secure clamp includes a T-rod and a plum nut, the T-rod passes through the left clamp and the right clamp, the plum nut threads into the T-rod, by setting the T-rod and the plum nut, the left clamp and the right clamp are tightened while ensuring that they are horizontal.

Further, the car cover includes a plurality of plate bodies, the lower side of the car cover is provided with a plate groove, which is used for connecting a wrench groove, the wrench groove is connected to the plate groove by glue, the wrench groove is used for connecting the wrench locking system.

An anti-detachment hook structure for a car cover, includes a secure clamp, a lifting hook and a retrofitting bar, the lifting hook is connected to the car cover, the retrofitting bar is provided with a retrofitting bar groove, the secure clamp includes a secure belt, a secure buckle and a clamp assembly, the clamp assembly is connected to the retrofitting bar groove, one end of the secure belt is connected to the car cover through the lifting hook, the other end of the secure belt is connected to the clamp assembly through the secure buckle; due to the difference in car models, some car cargo hoppers are wider while others are narrower, it is necessary to add a retrofitting bar in order to make the car cover adaptable to different car models, and the retrofitting bar groove is provided on the retrofitting bar, then the clamp assembly is connected to the retrofitting bar groove to ensure the stability of the secure clamp.

Further, the car cover includes a first rubber strip, a second connecting plate, a first connecting plate and a second rubber strip, the second rubber strip is provided with a first connecting surface and a second connecting surface, the first connecting plate is provided with a third connecting surface, the second connecting plate is provided with a fourth connecting surface, the first connecting surface is connected to the fourth connecting surface by glue, the second connecting surface is connected to the third connecting surface by glue.

An anti-detachment hook structure for a car cover, includes a secure clamp, a side rail, and an intermediate support bar, the intermediate support bar is connected to the car cover, the secure clamp includes a secure belt, a secure buckle, and a clamp assembly, the clamp assembly is connected to the side rail, one end of the secure belt is connected to the intermediate support bar, the other end of the secure belt is connected to the clamp assembly through the secure buckle, in order to increase the strength of the car cover, an intermediate support bar is added to increase the force strength of the car cover; the intermediate support bar is utilized to provide a connection point for the safety clamps, which enables the secure belts to be tied to the intermediate support bar between them.

An anti-detachment hook structure for a car cover, includes a secure clamp, a side rail and a side rail system, the side rail system includes a side rail groove and a side rail clamp, the side rail clamp is connected to the side rail groove, the secure clamp includes a secure belt, a secure buckle and a clamp assembly, the clamp assembly is connected to the side rail, one end of the secure belt is connected to the side rail clamp, the other end of the secure belt is connected to the clamp assembly by a secure buckle. In accordance with different car covers, some of the car covers are provided with a side rail system, which is utilized to connect the secure clamp to ensure the stability of the secure clamp, the side rail clamp is provided with a side rail clamp protrusion and a side rail clamp opening, the side rail clamp protrusion is connected to the side rail groove, the secure belt is connected to the side rail clamp opening, by providing the side rail clamp protrusion, the side rail clamps are stably connected to the side rail groove, by setting the side rail clamp opening, a fulcrum is providing for the connection of the secure belt, the clamp assembly includes a left clamp and a right clamp, the left clamp and the right clamp are connected by screws, the left clamp is provided with a left clamp fixing port, the secure buckle is connected to the left clamp fixing port.

The beneficial effects of the present invention are:

1. By providing a secure clamp, the present invention connects the car cover with the car to prevent it from slipping off while driving on a bumpy road, thus to improve the secure of the car cover.

Since different models adopt different connection methods, the present invention provides different connection methods for different models, which makes a better stability of the car cover after connection.

The secure clamp used in the present invention is not only of low cost, but the design of the secure belt makes it possible to have a good tension on the car cover while across the bumpy road

4. The car cover in the present invention is provided with a plate groove in certain places to facilitate the connection of the wrench groove, the wrench groove is used for installing the wrench.

### DESCRIPTION OF DRAWINGS

FIG. 1 is a usage schematic diagram I of the present invention;

FIG. 2 is a partially enlarged view of part A in FIG. 1;

FIG. 3 is a usage schematic diagram II of the present invention;

FIG. 4 is a partially enlarged view of part B in FIG. 3;

FIG. 5 is a schematic diagram of the plate groove in the present invention;

FIG. 6 is a usage schematic diagram III of the present invention

FIG. 7 is a partially enlarged view of part C in FIG. 6;

FIG. 8 is a usage schematic diagram IV of the present invention;

FIG. 9 is a partially enlarged view of part D in FIG. 8;

FIG. 10 is a usage schematic diagram V of the present invention;

FIG. 11 is a partially enlarged view of part E in FIG. 10;

FIG. 12 is a connection schematic diagram of the plate body in the present invention.

Figures: 1—Secure Clamp; 101—Secure Belt; 102—Secure Buckle; 103—Left Clamp; 1031—Left Clamp Fixing Port; 104—Screws; 105—T-Rod; 106—Plum Nut; 107—Right Clamp; 2—Side Rail; 3—Lifting Hook; 4—Plate Body; 401—Plate Groove; 402—Wrench Groove; 403—First Rubber Strips; 404—Second Connecting Plate; 4041—Fourth Connecting surface; 405—First connecting plate; 4051—Third Connecting Surface; 406—Second Rubber Strip; 4061—First Connecting Surface; 4062—Second Connecting Surface; 5—Intermediate Supporting Bar; 601—Side Rail Groove; 602—Side Rail Clamp; 6021—Side Rail Clamp Projection; 6022—Side Rail Clamp Opening; 7—Reinforcement Bar; 701—Reinforcement Rod Groove.

### The Concrete Method to Carry Out

The following instruction further explains the invention's concrete implementation method.

In order to enable a clearer understanding of the objects mentioned above, features and advantages of the present invention, the invention is described in detail below in connecting with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying drawings. It should be understood that the specific embodiments described herein are intended only to illustrate and explain the present invention and not to limit it.

### Embodiment 1

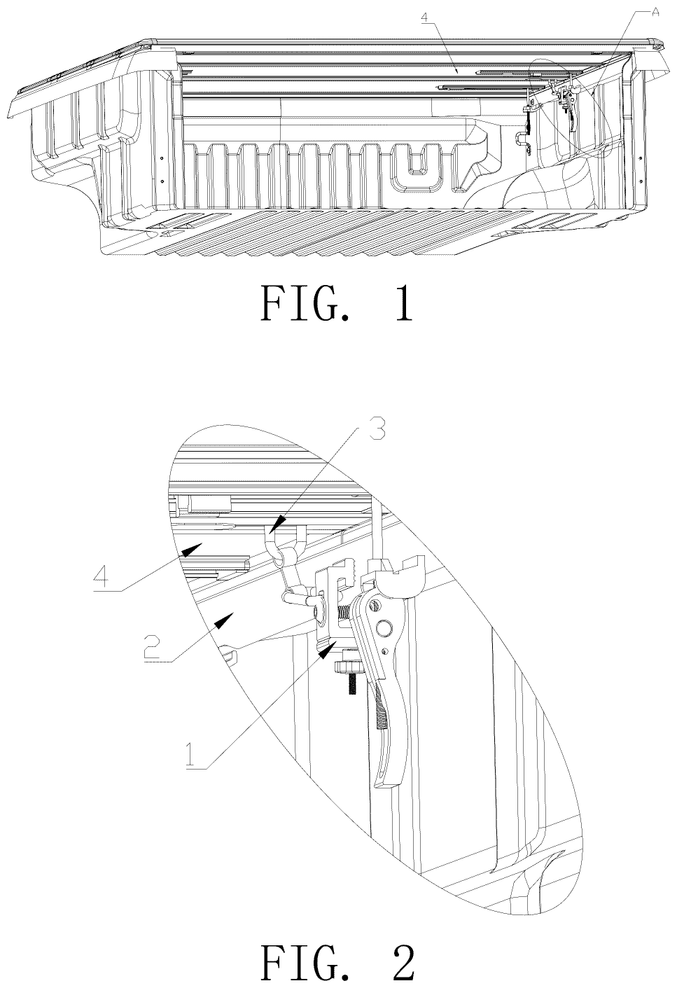

As shown in FIGS. 1 and 2, an anti-detachment hook structure for a car cover includes a secure clamp 1 and a lifting hook 3.

One end of the secure clamp 1 is connected to the car body or the side rail 2, the other end of the secure clamp 1 is connected to the car cover through the lifting hook 3.

By providing the secure clamp 1, the secure clamp 1 is utilized to connect the car cover to the side rails 2 or the car body to prevent the car cover from falling off when the car is traveling.

The car cover in includes a large front bar, a folding section and a tail bar, the folding section is connected between the large front bar and the tail bar, the large front bar is usually located on the side close to a front end of the car, wherein the large front bar cannot be opened, the car cover opens only the tail bar and the folding section, whereas the secure clamp 1 of the present invention is connected to the large front bar.

### Embodiment 2

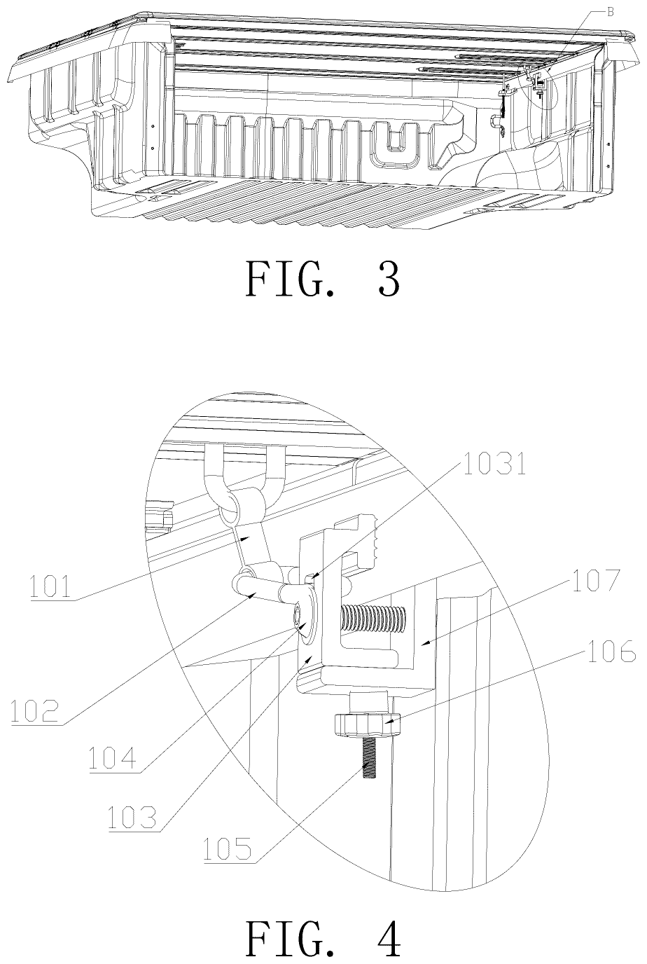

On the basis of embodiment 1, as shown in FIGS. 3 and 4, the secure clamp 1 includes a secure belt 101, a secure buckle 102, and a clamp assembly, the clamp assembly is connected to the car body or the side rail 2, the clamp assembly is connected to the secure buckle 102, the secure buckle 102 is connected to the lifting hook 3 by the secure belt 101, both the secure buckle 102 and the lifting hook 3 are made of metal or made of high-strength plastics, both the secure buckle 102 and the lifting hook 3 can be made of metal or high strength plastic, or one of them can be made of metal and the other one can be made of high strength plastic.

The clamp assembly is used to connect the side rail 2 to the car body, the secure clamp 1 is in the form of a secure buckle 102 and a secure belt 101, the secure buckle 102 and the secure belt 101 are utilized to connect the lifting hook 3 and the clamp assembly, the secure belt 101 is of certain elasticity, so that the secure clamp 1 will not cause any damage to the cover or the car body when the car passes through a bumpy roadway, and the secure belts 101 are able to pull the car cover tightly.

### Embodiment 3

On the basis of Embodiment 2, the clamp assembly includes a left clamp 103 and a right clamp 107, the left clamp 103 and the right clamp 107 are connected by screws 104, the left clamp 103 is provided with a left clamp fixing port 1031, the secure buckle 102 is connected to the left clamp fixing port 1031.

The clamp assembly is used to clamp the car cover to the side rail 2 so that the car cover can fit various car models. As the left clamp 103 is located on the inner side (here the inner side refers to the side close to the center of the cargo hopper), the left clamp fixing port 1031 is provided on the left clamp 103 for connecting the secure buckle 102.

The left clamp fixing port 1031 can be set up separately, or the left clamp fixing port 1031 can also be set in connection with the tension port (here the tension port refers to the port for passing through the screws 104), which facilitates the processing of the left clamp fixing port 1031.

The secure clamp 1 further includes a T-rod 105 and a plum nut 106, the T-rod 105 passes through the left clamp 103 and the right clamp 107, the plum nut 106 threads into the T-rod 105.

By setting the T-rod 105 and the plum nut 106, the left clamp 103 and the right clamp 107 are tightened while ensuring that they are horizontal.

The screw 104 clamps the left clamp 103 and the right clamp 107 in the horizontal direction, the T-rod 105 and the plum nut 106 clamp the left clamp 103 and the right clamp 107 in the vertical direction, since both the bottom of the left clamp 103 and the right clamp 107 are provided with a flat surface, the T-rod 105 and the plum nut 106 clamp the left clamp 103 and the right clamp 107 to ensure that the left clamp 103 and right clamp 107 are flush.

While installing, the lifting hook 3 is connected to the inner side of the car cover, the side rail 2 is clamped to the car body using the clamp assembly, then the car cover is placed on the side rail 2, the secure clamp 1 is used to connect the lifting hook 3 and the clamp assembly.

### Embodiment 4

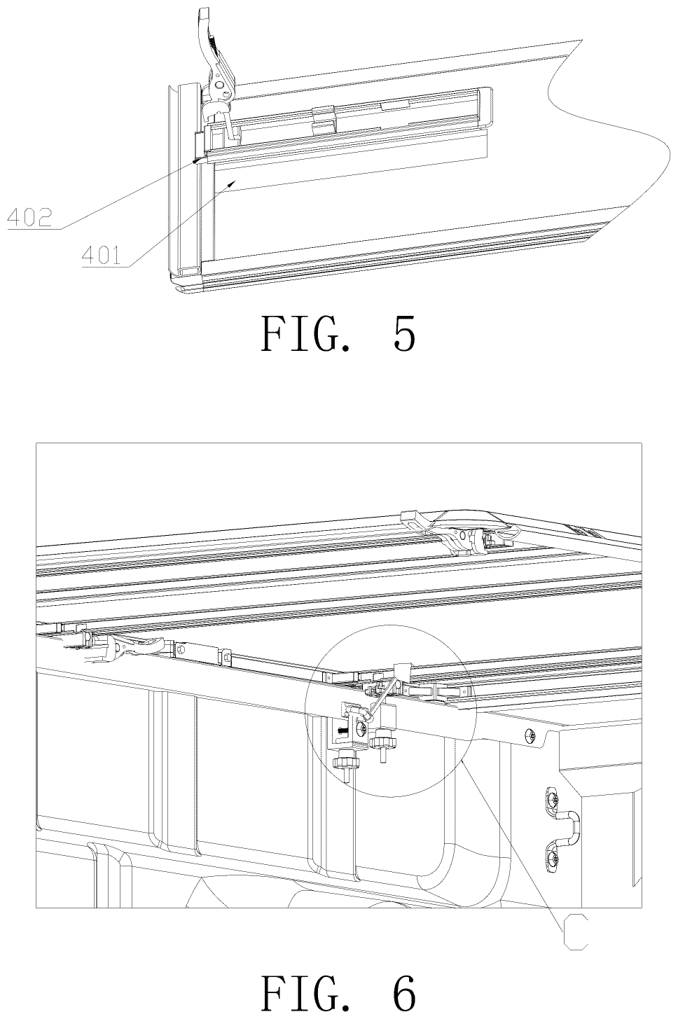

On the basis of Embodiment 3, as shown in FIG. 5, the car cover includes a plurality of plate bodies 4.

The lower side of the car cover is provided with a plate groove 401, which is used for connecting a wrench groove 402, the wrench groove 402 is connected to the plate groove 401 by glue.

The wrench groove 402 is used for connecting the wrench locking system.

### Embodiment 5

As shown in FIGS. 1-4, 10 and 11, an anti-detachment hook structure for a car cover includes a secure clamp 1, a lifting hook 3 and a retrofitting bar 7.

The lifting hook 3 is connected to the car cover.

The retrofitting bar 7 is provided with a retrofitting bar groove 701.

The secure clamp 1 includes a secure belt 101, a secure buckle 102 and a clamp assembly, the clamp assembly is connected to the retrofitting bar groove 701, one end of the secure belt 101 is connected to the car cover through the lifting hook 3, the other end of the secure belt 101 is connected to the clamp assembly through the secure buckle 102.

Due to the difference in car models, some car cargo hoppers are wider while others are narrower, it is necessary to add a retrofitting bar 7 in order to make the car cover adaptable to different car models, and the retrofitting bar groove 701 is provided on the retrofitting bar 7, then the clamp assembly is connected to the retrofitting bar groove 701 to ensure the stability of the secure clamp 1.

While installing, the lifting hook 3 is connected to the inner side of the car cover, the side rail 2 is clamped to the car body by using the clamp assembly, then the car cover is placed on the side rail 2, and the side rail 2 is connected to the front rail by using the retrofitting bar 7, and finally, the secure clamp 1 connects the lifting hook 3 and the clamp assembly to the car body.

### Embodiment 6

On the basis of Embodiment 5, as shown in FIG. 11, the car cover includes a first rubber strip 403, a second connecting plate 404, a first connecting plate 405, and a second rubber strip 406, the second rubber strip 406 is provided with a first connecting surface 4061 and a second connecting surface 4062, the first connecting plate 405 is provided with a third connecting surface 4051, the second connecting plate 404 is provided with a fourth connecting surface 4041, the first connecting surface 4061 is connected to the fourth connecting surface 4041 by glue, the second connecting surface 4062 is connected to the third connecting surface 4051 by glue, the first glue strip 403 is also glued.

Since the car cover needs to be flipped and folded, the connections are glued at the joints to prevent water leaking at the joints.

### Embodiment 7

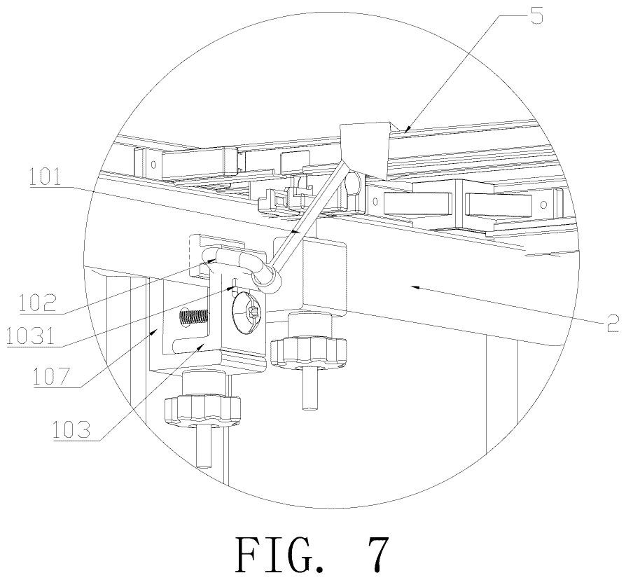

As shown in FIGS. 1-4, 6 and 7, an anti-detachment hook structure for a car cover includes a secure clamp 1, a side rail 2 and an intermediate support bar 5.

The intermediate support bar 5 is connected to the car cover.

The secure clamp 1 includes a secure belt 101, a secure buckle 102 and a clamp assembly, the clamp assembly is connected to the side rail 2, one end of the secure belt 101 is connected to the intermediate support bar 5, the other end of the secure belt 101 is connected to the clamp assembly through the secure buckle 102.

In order to increase the strength of the car cover, the intermediate support bar 5 is added to increase the force strength of the car cover, the intermediate support bar 5 is utilized to provide a connection point for the secure clamps 1, which enables the secure belts 101 to be tied between the intermediate support bar 5.

While installing, the side rails 2 are clamped to the car body using the clamp assembly, then the car cover is placed on the side rails 2, the intermediate support bar 5 is utilized to connect the side rails 2 to the front rails, and finally, the secure clamp 1 connects the lifting hook 3 to the clamp assembly.

### Embodiment 8

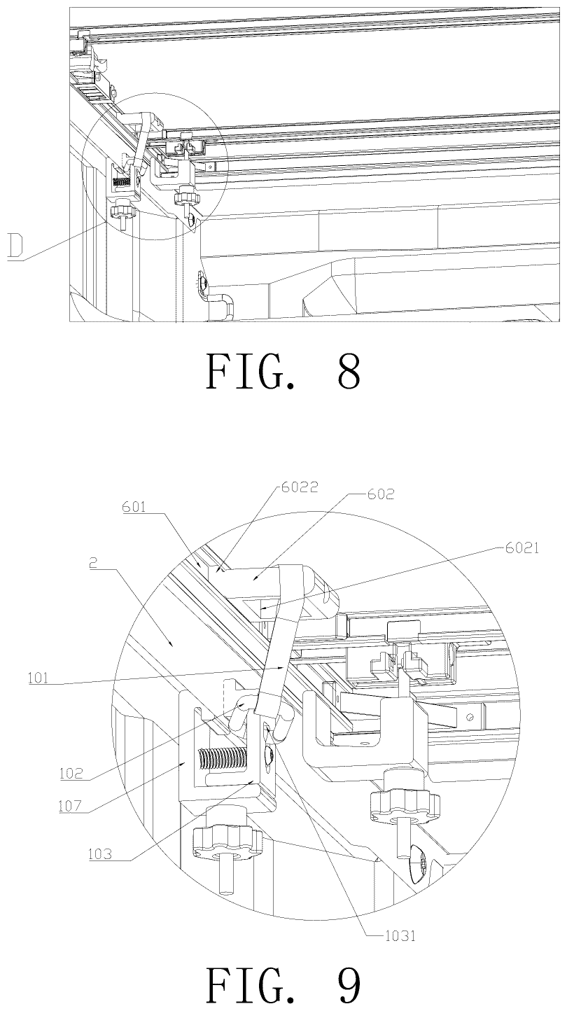

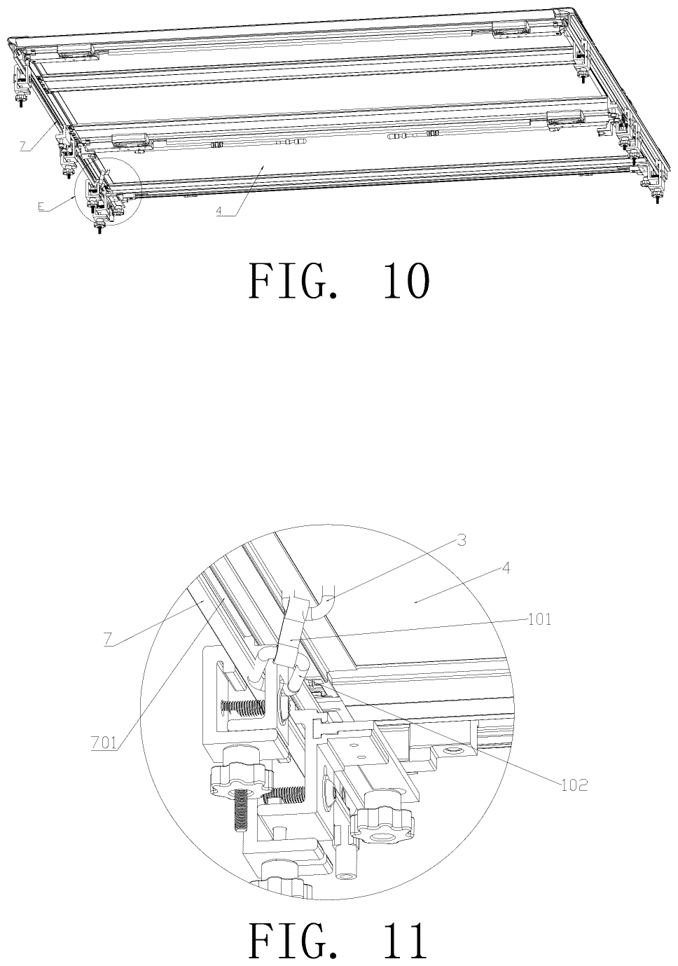

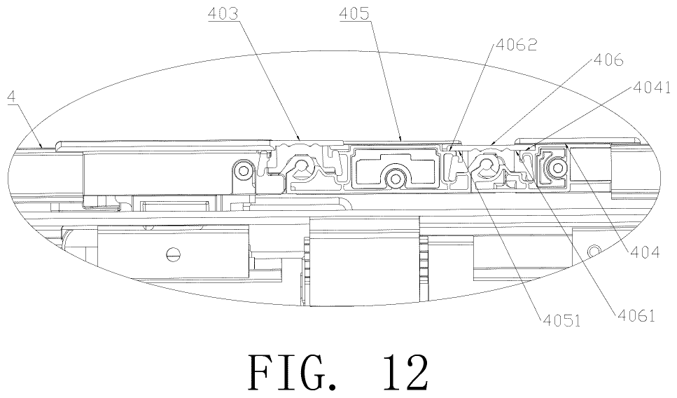

As shown in FIGS. 1-4, 8 and 9, an anti-detachment hook structure for a car cover includes a secure clamp 1, a side rail 2 and a side rail system.

The side rail system includes a side rail groove 601 and a side rail clamp 602, the side rail clamp 602 is connected to the side rail groove 601.

The secure clamp 1 includes a secure belt 101, a secure buckle 102 and a clamp assembly, the clamp assembly is connected to the side rail 2, one end of the secure belt 101 is connected to the side rail clamp 602, the other end of the secure belt 101 is connected to the clamp assembly by the secure buckle 102.

In accordance with different car covers, some car covers are provided with a side rail system, which is utilized to connect the secure clamp 1 to ensure the stability of the secure clamp 1. The side rail clamp 602 is provided with a side rail clamp projection 6022 and a side rail clamp opening 6021, the side rail clamp projection 6022 is connected to the side rail groove 601, the secure belt 101 is connected to the side rail clamp opening 6021.

By providing side rail clamp projections 6022, the side rail clamps 602 are stably connected to the side rail groove 2, by setting side rail clamp openings 6021, a fulcrum is provided for the connection of the seat belt 101.

The clamp assembly includes a left clamp 103 and a right clamp 107, the left clamp 103 and the right clamp 107 are connected by screws 104, the left clamp 103 is provided with a left clamp fixing port 1031, the secure buckle 102 is connected to the left clamp fixing port 1031.

While installing, the side rails 2 are clamped to the car body using the clamp assembly, then the cover is placed on the side rails 2, the side rails 2 are connected to the front rails using the intermediate support bar 5, and finally the secure clamp 1 connects the lifting hooks 3 to the clamp assembly.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. An anti-detachment hook structure for a car cover, wherein, it includes a secure clamp (1) and a lifting hook (3);
One end of the secure clamp (1) is connected to the car body or side rails (2), the other end of the secure clamp (1) is connected to the car cover of the car by the lifting hook (3).

2. An anti-detachment hook structure for a car cover according to claim 1, wherein, the secure clamp (1) includes a secure belt (101), a secure buckle (102) and a clamp assembly, the clamp assembly is connected to the car body or the side rails (2), the clamp assembly is connected to a secure buckle (102), the secure buckle (102) is connected to the lifting hook (3) by the secure belt (101).

3. An anti-detachment hook structure for a car cover, wherein, it includes a secure clamp (1), a lifting hook (3) and a retrofitting bar (7);
The lifting hook (3) is connected to the car cover;
The retrofitting bar (7) is provided with a retrofitting bar groove (701);
The secure clamp (1) includes a secure belt (101), a secure buckle (102) and a clamp assembly, the clamp assembly is connected to the retrofitting bar groove (701), one end of the secure belt (101) is connected to the car cover of the vehicle through the lifting hook (3), the other end of the secure belt (101) is connected to the clamp assembly through the secure buckle (102).

4. An anti-detachment hook structure for a car cover, wherein, it includes a secure clamp (1), a side rail (2) and an intermediate support bar (5);
The intermediate support bar (5) is connected to the car cover;
The secure clamp (1) includes a secure belt (101), a secure buckle (102) and a clamp assembly, the clamp assembly is connected to the side rails (2), one end of the secure belt (101) is connected to the intermediate support bar (5), the other end of the secure belt (101) is connected to the clamp assembly through the secure buckle (102).

5. An anti-detachment hook structure for a car cover, wherein, it includes a secure clamp (1), a side rail (2) and a side rail system;
The side rail system includes a side rail groove (601) and a side rail clamp (602), the side rail clamp (602) is connected to the side rail groove (601);
The secure clamp (1) includes a secure belt (101), a secure buckle (102) and a clamp assembly, the clamp assembly is connected to the side rail (2), one end of the secure belt (101) is connected to the side rail clamp (602), the other end of the secure belt (101) is connected to the clamp assembly by a secure buckle (102).

6. An anti-detachment hook structure for a car cover according to any one of claims 1-5, wherein, the clamp assembly includes a left clamp (103) and a right clamp (107), the left clamp (103) and the right clamp (107) are connected by screws (104), the left clamp (103) is provided with a left clamp fixing port (1031), the secure buckle (102) is connected to the left clamp fixing port (1031), both the secure buckle (102) and the lifting hook (3) are made of metal or high strength plastic.

7. An anti-detachment hook structure for a car cover according to claim 5, wherein, the side rail clamp (602) is provided with a side rail clamp protrusion (6022) and a side rail clamp opening (6021), the side rail clamp protrusion (6022) is connected to the side rail groove (601), the secure belt (101) is connected to the side rail clamp opening (6021).

8. An anti-detachment hook structure for a car cover according to claim 6, wherein, the secure clamp (1) further includes a T-rod (105) and a plum nut (106), the T-rod (105) passes through the left clamp (103) and the right clamp (107), the plum nut (106) threads into the T-rod (105).

9. An anti-detachment hook structure for a car cover according to claim 1, wherein, the car cover includes a plurality of plate bodies (4);
The lower side of the car cover is provided with a plate groove (401), which is used for connecting a wrench groove (402), the wrench groove (402) is connected to the plate groove (401) by glue;
The wrench groove (402) is used for connecting the wrench locking system.

10. An anti-detachment hook structure for a car cover according to claim 1, wherein, the car cover includes a first rubber strip (403), a second connecting plate (404), a first connecting plate (405), and a second rubber strip (406), the second rubber strip (406) provided with a first connecting surface (4061) and a second connecting surface (4062), the first connecting plate (405) is provided with a third connecting surface (4051), the second connecting plate (404) is provided with a fourth connecting surface (4041), the first connecting surface (4061) is connected to the fourth connecting surface (4041) by glue, the second connecting surface (4062) is connected to the third connecting surface (4051) by glue.
